(19) United States
(12) Patent Application Publication
(10) Pub. No.: US 2016/0246582 A1
(43) Pub. Date: Aug. 25, 2016

(54) Generic Semantic Configuration Service

(71) Applicant: Red Hat, Inc., Raleigh, NC (US)

(72) Inventor: William Christian Benton, Madison, WI (US)

(21) Appl. No.: 14/630,799

(22) Filed: Feb. 25, 2015

(51) Int. Cl. G06F 9/445; G06F 11/36; G06F 9/45

(52) U.S. Cl. CPC G06F 8/61; G06F 8/40; G06F 11/3608

(57) ABSTRACT

Implementations provide for generic semantic configuration service for computer systems. A method of the disclosure includes installing, by a processing device, an abstract data structure representing an application, the abstract data structure comprising representation objects corresponding to high-level features of the application, installing a semantic model for the application, receiving an identification of at least one of the high-level features to be configured on at least one component executing the application, validating, using the semantic model, a configuration of the representation objects of the abstract data structure corresponding to the at least one of the high-level features, and generating low-level configuration code in a machine-readable format of the application from the representation objects corresponding to the at least one of the high-level features.

### TECHNICAL FIELD

The implementations of the disclosure relate generally to computer systems and, more specifically, relate to generic semantic configuration service for specifying, validating, and deploying configurations for arbitrary computer systems.

### BACKGROUND

Distributed systems include multiple autonomous computational entities (i.e., components) communicating with each other. Configurations and configuration parameters can specify the identities of machines and services participating in a distributed system. The configurations and configuration parameters can enable, disable, or customize the operation of particular functionality in the distributed system, and can specify policies including access control, user roles, how to resolve conflicts, and so on. Each of the components of the distributed system may be implemented with numerous configuration parameters (“configurations”).

Managing configurations for distributed systems having multiple components is difficult. There are several difficulties including versioning and differencing configurations, determining which components are to be restarted when a configuration changes, deploying updated configurations to affected nodes (virtual or physical), ensuring that each node is running the correct version of a configuration, translating from high-level business requirements to deployable and machine-readable configurations, and validating that configurations meet various safety and correctness properties before deploying them.

Checking configuration validity can be particularly challenging because the configurations corresponding to certain business requirements may depend on additional configurations or may conflict with one another in subtle ways. Furthermore, in a distributed system, the configurations of individual nodes or individual services may depend on one another or conflict as well. In addition, the configurations of distributed system components typically are specified in low-level machine-readable formats. These low-level formats are possible for users to edit, but generally require a user with expertise in the low-level format to manage.

### BRIEF DESCRIPTION OF THE DRAWINGS

The disclosure will be understood more fully from the detailed description given below and from the accompanying drawings of various implementations of the disclosure. The drawings, however, should not be taken to limit the disclosure to the specific implementations, but are for explanation and understanding only.

FIG. 1 is a block diagram of a network architecture for providing a generic configuration management service according to implementations of the disclosure.

FIG. 2 is a block diagram of an administration server including a generic configuration management component and a data store according to implementations of the disclosure.

FIG. 3 is a flow diagram illustrating a method for providing a generic semantic configuration service for computer systems according to an implementation of the disclosure.

FIG. 4 is a flow diagram illustrating a method for generating an abstract structure in a generic semantic configuration service for computer systems according to an implementation of the disclosure.

FIG. 5 is a flow diagram illustrating a method for applying a semantic model for configuration validation in a generic semantic configuration service for computer systems according to an implementation of the disclosure.

FIG. 6 is a flow diagram illustrating a method for translating structures of an abstract structure into low-level configuration code in a generic semantic configuration service for computer systems according to an implementation of the disclosure.

FIG. 7 illustrates a block diagram of one implementation of a computer system.

### DETAILED DESCRIPTION

Implementations of the disclosure provide for generic semantic configuration service for specifying, validating, and deploying configurations for arbitrary computer systems. The generic configuration management service of implementations of the disclosure provides a framework for declaring semantic models of system-specific configurations, which it uses to (1) map from high-level specifications of system behaviors to low-level, machine-readable configuration files, (2) prove properties of configurations before installing them on a distributed system, (3) determine how changes to a configuration affect the behavior of the system, and (4) identify differences between configurations.

In implementations of the disclosure, a semantic model may refer to a mathematical object that models some safety and/or correctness properties of configurations and is amenable to automated validation. As an example, a semantic model may be used to prove that a program does not attempt to take the square root of a string of characters, or to prove that an optimizing compiler produces programs that have the same behavior as unoptimized versions. In some implementations, configurations for a particular system may be modeled using a semantic model as directed graph labels that obey certain constraints (e.g., acyclicity) or satisfy certain properties.

In one implementation, a semantic model may be defined formally with the following components: (1) an abstract representation of configurations and partial configurations that includes enough information to faithfully reproduce concrete configurations translated to and from it and models properties of interest for configuration validation; (2) a set of rules (or a high-level interface) for generating concrete configurations from these abstract representations; (3) a set of rules (or a high-level interface) for generating abstract representations of configurations; and (4) a set of rules describing properties that must hold in the abstract representations of a valid configuration (or, alternatively, a procedure to validate abstract representations).

Referring to the abstract representation of the configurations, this abstract representation may be analogous to an abstract syntax tree for a programming language. In some implementations the abstract representation is a tree or graph structure, but is not limited to such structure (e.g., could be a row-oriented or logic database as well). Referring to the set of rules for generating abstract representations, these set of rules may provide a way to generate abstract representations of configurations and should be sufficiently general both to generate abstract representations from (complete or partial) concrete configurations and to build facilities that generate abstract representations from higher-level descriptions of configurations.

Lastly, referring to the set of rules describing properties, these set of rules can be either a set of properties that hold for valid configurations (in which case the logical properties of the semantic model are used to automatically generate a procedure to validate abstract configurations) or a validation procedure. One benefit of the semantic modeling approach described above is when these set of rules are specified as a set of properties, as implementations of the disclosure can then make assurances about the correctness of an abstract configuration without depending on the correctness of a user-specified validation procedure.

A distributed system can include several autonomous computational entities (i.e., components) communicating with each other. Each of the components of the distributed system may be implemented with numerous configuration parameters (“configurations”). Managing configurations for distributed systems having multiple components is difficult. The generic configuration management service of implementations of the disclosure allows users (e.g., such as a system administrator) to specify configurations for any type of service or application executed by a distributed system in a human-readable format and then generate the specified configurations in low-level, machine-readable format for deployment out to components of the distributed system.

In one implementation, the generic configuration management service includes a versioned storage service that contains one or more abstract structures (e.g., tree, graph, row-oriented database, logic database, map, set, any combination or composition of the above, etc.) having representations (also referred to as “objects” herein) of configuration-domain entities (e.g., features corresponding to business requirements, nodes, services, etc.) and relationships between those representations. In some implementations, the abstract structure is also referred to a an abstract data structure. Each abstract structure is a representation of a configuration and an object in the domain of the semantic model described above. The generic configuration management service may generate and maintain an abstract structure for each service or application using the generic configuration management service for deployment of configuration data to components of a distributed system providing the service or application.

Prior solutions for configuration management did not allow for generic specification of any type of application or service. Furthermore, prior solutions for configuration management did not provide for a user-friendly implementation for generating low-level configuration code. Lastly, prior solutions for configuration management did not introduce a semantic model for configuration validation where the configuration validation itself ensured correct and accurate configurations. Implementations of the disclosure overcome the drawbacks of prior solutions by providing a framework for declaring semantic models and then using the declared semantic models to prove properties of configurations for services deployed on any type of distributed system. In addition, the semantic model of implementations of the disclosure can support a user-friendly interface for specifying configuration or partial configurations.

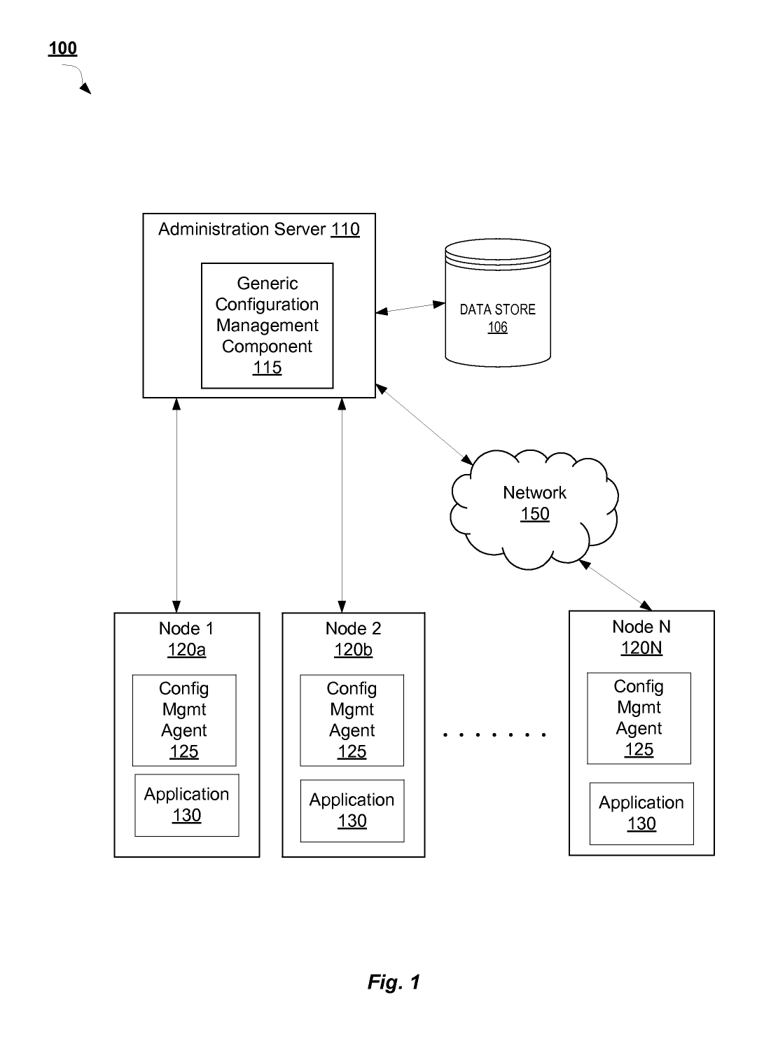

FIG. 1 is a block diagram of a network architecture 100 for providing a generic configuration management service according to implementations of the disclosure. Network architecture 100 may include an administration server 110 communicably coupled to one or more nodes 120a-120N either directly and/or via a network 150. Network 150 can be a local area network (LAN), a wireless network, a telephone network, a mobile communications network, a wide area network (WAN), such as the Internet, or similar communication system.

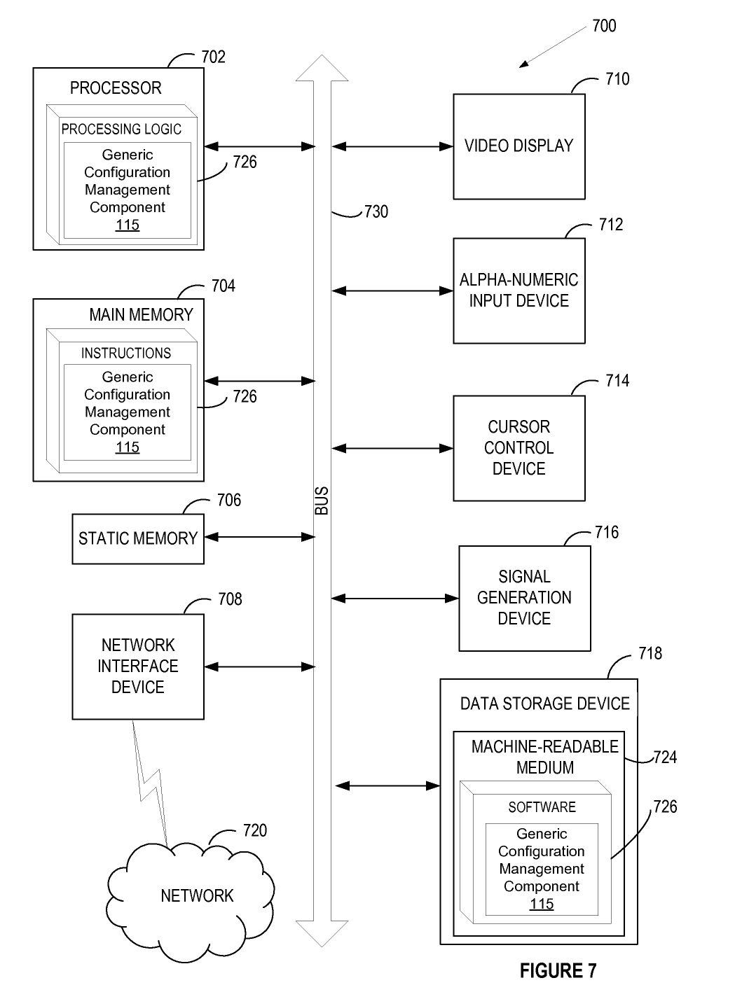

Administration server 110 may be any type of computer system including, but not limited to, server computers, gateway computers, desktop computers, laptop computers, mobile communications devices, cell phones, smart phones, hand-held computers, tablets, or similar computing devices. A computer system herein may refer to a system comprising one or more processors, one or more memory devices, and/or one or more input/output (I/O) interfaces. Administration server 110 may include, for example, computer system 700 of FIG. 7.

Administration server 110 may include a generic configuration manage component 115 to provide a framework for declaring semantic models and then use the declared semantic models to prove properties of configurations (also referred to as “configuration parameters”) for applications and/or services deployed on nodes 120a-120N.

Nodes 120a-120N may be any type of computing system including, but not limited to, server computers, gateway computers, desktop computers, laptop computers, mobile communications devices, cell phones, smart phones, hand-held computers, tablets, or similar computing devices. Nodes 120a-120N may include, for example, computer system 700 of FIG. 7.

In one implementation, node 120a-120N may be a computer system running an operating system and one or more applications 130. Each of those applications 130, as well as the underlying operating systems, virtual machines, and hardware, may have numerous configuration parameters designed to control various operational aspects of the respective application, virtual machines, operating systems, and/or hardware. Examples of configuration parameters may include hardware configuration parameters, operating system configuration parameters, virtual machine configuration parameters, and/or application configuration parameters. A configuration management component may be employed to assign values to the configuration parameters of a computer system.

The generic configuration management component 115 allows users (e.g., such as a system administrator) to specify configurations for any type of service or application 130 executed by a node 120a-120N in a human-readable format and then generate the specified configurations in low-level machine-readable format for deployment out to noes 120a-120N. Each node 120a-120N may include a configuration management 125 that operates in conjunction with generic configuration management component 115 to enable generic configuration management on each of the nodes 120a-120N. For example, the configuration management agent 125 may respond to notifications from the generic configuration management component 115 and checks in periodically with the generic configuration management component 115. The agent 125 may receive new configurations from the generic confirmation management component 115 and causes the configuration to be installed at the node 120a-120N. Configuration management agents 125 do not have to be utilized in some implementations of the disclosure, although they do enable the system 100 to achieve greater scale. It is possible, for example, to have the configuration service connect to remote machine (e.g., via a SSH connection) install new configurations, and the restart services as needed.

In one implementation, the generic configuration management component 115 generates and maintains, in data store 106, one or more abstract structures (e.g., tree, graph, row-oriented databases, logic databases, maps, sets, any combination or composition of the above, etc.) Each abstract structure represents a configuration and an object in the domain of the semantic model described above. In one implementations, the abstract structures include representations (e.g., data such as name, properties, attributes, relations) for configuration-domain entities (e.g., features corresponding to business requirements, nodes, services, etc.) and relationships between those representations.

Data store 106 may include one or more mass storage devices which can include, for example, flash memory, magnetic or optical disks, or tape drives, read-only memory (ROM); random-access memory (RAM); erasable programmable memory (e.g., EPROM and EEPROM); flash memory; or any other type of storage medium.

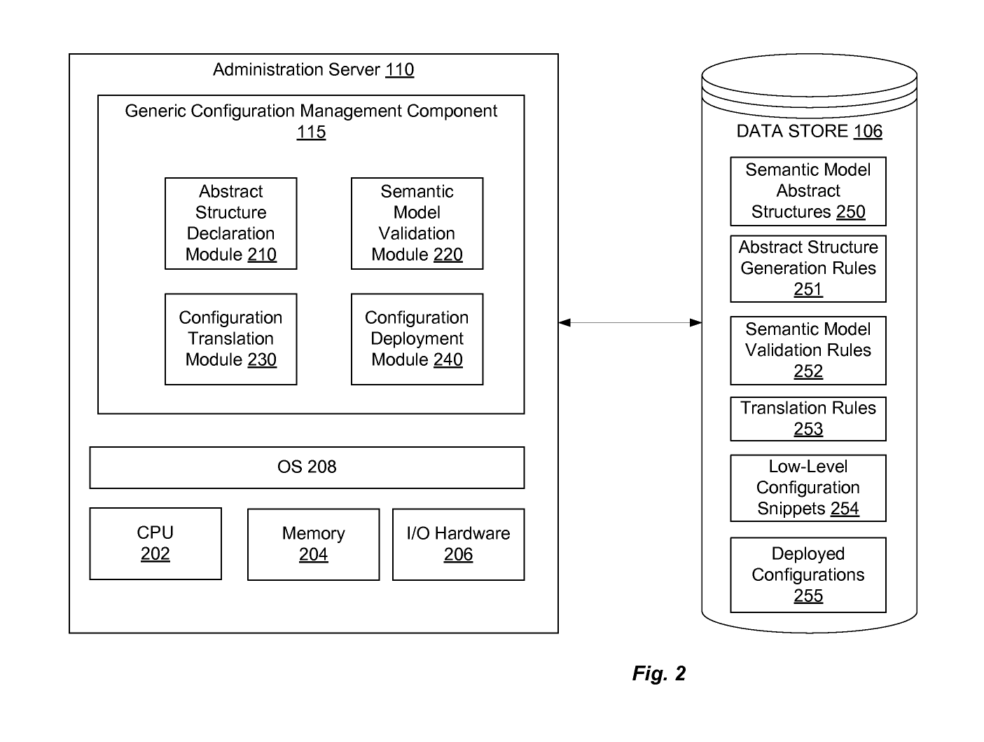

The generic configuration management component 115 may generate and maintain an abstract structure for each service or application 130 using the generic configuration management service. As such, generic configuration management component 115 is adaptable to provide a facility to define models for new and/or previously-unknown services, which may not have existed at the time of implementation of the generic configuration management component 115. In other words, the generic configuration management component 115 is fully generic in that it can be extended by users to model systems and services that its authors have not anticipated. Further details of application server 110 and generic configuration management component 115 are described below with respect to FIG. 2.

FIG. 2 is a block diagram of an administration server 110 including a generic configuration management component 115 and a data store 106 according to implementations of the disclosure. In one implementation, administration server 110, generic configuration management component 115, and data store 106 are the same as their counter parts described with respect to FIG. 1.

Administration server 110 may include a hardware platform with components such as a CPU (also referred to as a processor or a processing device) 202, a memory 206, and I/O interface hardware 206. More or less components than described herein may be included in administration server 110. An operating system 108 may be executed from memory 204 by CPU 202 on administration server 110. OS 208 may cause the generic management component 115 to be executed on administration server 110.

Generic configuration management component 115 may include an abstract structure declaration module 210, a semantic model validation module 220, a configuration translation module 230, and a configuration deployment module 240.

The abstract structure declaration module 210 may provide a domain-specific declarative language (or other high-level interface) for mapping from high-level descriptions of functionality to representations in an abstract structure. The high-level descriptions of functionality (also referred to herein as “high-level features”) may include a human-readable description to define a feature of the service/application utilizing the generic configuration management component 115. For example, for a resource manager application, the high-level description of functionality referred to as “high-availability scheduler” may represent a set of configuration parameters that providing functionality including a list of services that are to be run with redundant replicas that include the scheduler service, the URL of a lock file used by the currently active replica, the locations of shared state so that passive replicas can take over if the active replica fails, and a polling interval for passive replicas to check in with the active replica. Instead of the user (e.g., a system administrator) having to remember and list the low-level parameters, the user can instead refer to the high-level description of the functionality, namely “high-availability scheduler”.

The abstract structure may be stored in semantic model abstract structures 250 (also referred to as abstract data structure) of data store 106 and may include any type of generic data representation, such as a tree, a graph, row-oriented database (e.g., bag of tuples, each with a fixed arity), logic databases (bags of relations or tuples of variable arity combined with rules to synthesize implicit relations), maps, sets, any combination or composition of the above, and so on. The format of the abstract structure 250 is unrestricted to allow users flexibility in generating the abstract structure. The abstract structure 250 may include representation objects, which may include data such as name, properties, attributes, and relations, for the high-level description of functionality (such as configuration-domain entities including features corresponding to business requirements, nodes, services, etc.) and relationships between those representation objects. The relationships between the representation objects in an abstract structure 250 may indicate, for example, whether representation objects depend on one another, subsume one another, conflict with one another, extend one another, and so on. Other relationships between representation objects may be also be indicated in the abstract structure 250, as well.

A set of abstract structure generation rules 251 (e.g., stored in state store 106) define how high-level features are transformed into the representation objects in the abstract structure 250. In one implementation, a user, such as a domain expert in the field of the application or service utilizing the generic configuration management component 115, may define the abstract structure generation rules for the particular application. For example, abstract structure generation rules 251 may be a set of procedures to translate and/or map the features of the high-level description into the specific format of the representation object stored in the abstract structure 250, as well as procedures to indicate relationships between representation objects in the abstract structure 250.

In one implementation, utilization of the abstract structure 250 as the representation for high-level features (and relationships there between) of a service/application allows for the generic configuration management component 115 to perform differencing using the abstract structure 250. For example, the differencing may be used for version control and determining which nodes in a distributed system require updates due to configuration changes.

The semantic model validation module 220 may provide a domain-specific declarative language (or other high-level interface) for expressing a semantic model of configuration validity and rules to check that representation objects in a generated abstract structure 250 satisfy certain safety and/or correctness properties under the semantic model. The semantic model validation module 220 may be invoked when a user of the generic configuration management component 115 indicates a set of high-level features to be configured on one or more nodes of the distributed system. The set of high-level features correspond to one or more representation objects in an abstract structure 250 generated by the abstract structure declaration module 210, as described above.

The semantic model validation module 220 applies semantic model validation rules 252 to the corresponding representation objects of the requested high-level features in the abstract structure 250. Semantic model validation module 220 utilizes a semantic model defined for the abstract structure. The semantic model refers to a set of rules verifying that a requested configuration fulfills dependencies between high-level features and parameters, avoids installing conflicting features, and provides meaningful user-friendly feedback immediately after requested configuration changes that would introduce errors. IN addition, the rules of the semantic model specify priorities among configurations (e.g., if there are two different features and one is more specific, then the specific feature takes precedence over the less-specific feature).

In one implementation, the rules of the semantic model may be generated and specified by a domain expert in the field of the service/application. In other implementations, the rules of the semantic model may be specified by any user, such as a system administrator of the service/application. The rules of the semantic model may be stored as semantic model validation rules 252 in data store 106.

To semantic model validation rules 252 may be applied against the representation objects in the abstract structure 250 representing the high-level features requested for the configuration. The information stored in the representation objects and the relationships indicated between the representation objects can be used by the semantic model validation module 220 to confirm a valid configuration via the semantic model validation rules 252. In one example, a set of semantic model validation rules 252 may a set of procedures that specify that a valid configuration includes the following properties, as exhibited by the corresponding representation objects in the abstract structure 250: abstract structure implied by the feature-inclusion relation must be acyclic; if a first high-level feature conflicts with a second high-level feature, both features cannot be installed on the same node; if a first high-level feature depends on a second high-level feature, a node whose configuration installs the first high-level feature must also install the second high-level feature; and high-level features cannot conflict with themselves (e.g., a high-level feature cannot include or depend upon a feature that it conflicts with). Other semantic model validation rules 252 may be created for a service/application depending on the preferences of system administrators configuring the generic configuration management component 115 for the service/application.

Once a requested configuration is validated by the semantic model validation module 220, the configuration translation module 230 may provide a domain-specific declarative language (or other high-level interface) for expressing rules to synthesize low-level machine-readable configuration files (also referred to as “low-level configuration files”) from representation objects in the abstract structure 250. Synthesizing representation objects from the abstract structure 250 into low-level configuration files may refer to the set of procedures to translate an representation object into a concrete machine-readable format (e.g., eXtensible Markup Language (XML), etc.) specified for the configuration file. In some implementations, the configuration translation module 230 may synthesize multiple high-level features into many low-level configuration lines that represent the multiple piece of high-level functionality of the high-level features.

In one implementation, each representation object for a high-level feature in the abstract structure 250 corresponds to a piece of machine-readable code, referred to as a low-level configuration snippet 254, optionally stored in data store 106. For example, in a service that had an installed model for resource-manager application, the high-level feature “high-availability schedd” may correspond to the following low-level configuration snippet 254:

MASTER_HA_LIST = $(MASTER_HA_LIST), SCHEDD
HA_LOCK_URL = file:$(SPOOL)
VALID_SPOOL_FILES = $(VALID_SPOOL_FILES), SCHEDD.lock
SCHEDD_NAME = schedhost
SCHEDD.QMF_STOREFILE = $(SPOOL)/.schedd_storefile
HA_LOCK_HOLD_TIME = 300
HA_POLL_PERIOD = 60

In one implementation, representation objects in the abstract structure 250 may provide a reference to where the low-level configuration snippet 254 corresponding to the representation object is stored. In other implementations, the low-level configuration snippet 254 corresponding to an representation object is stored with the representation object in the abstract structure 250. In either case, configuration translation module 230 utilizes translation rules 253 to generate a set of low-level machine-readable configuration lines corresponding to a configuration requested for one or more high-level features. Translation rules 253 may be created by a user, such as a domain expert in the field of the service/application corresponding to the configuration, and stored in data store 106 for reference by configuration translation module 230. Configuration translation module 230 insulates users from having to deal with the low-level configuration files associated with a service/application and instead lets the user specify the high-level user-visible components of functionality that they are interested in configuring for a component in a distributed system.

Once a low-level configuration file is generated by configuration translation module 230, the configuration deployment module 240 may provide a service to efficiently verify and deploy the updated configurations 255 from the representation objects in the abstract structure. As discussed above, the configuration deployment module 240 may perform a differencing on the abstract structure 250 to determine which components in the distributed system are to receive the updated deployed configurations 255. In some implementations, the deployed configurations 255 may optionally be stored in data store 106.

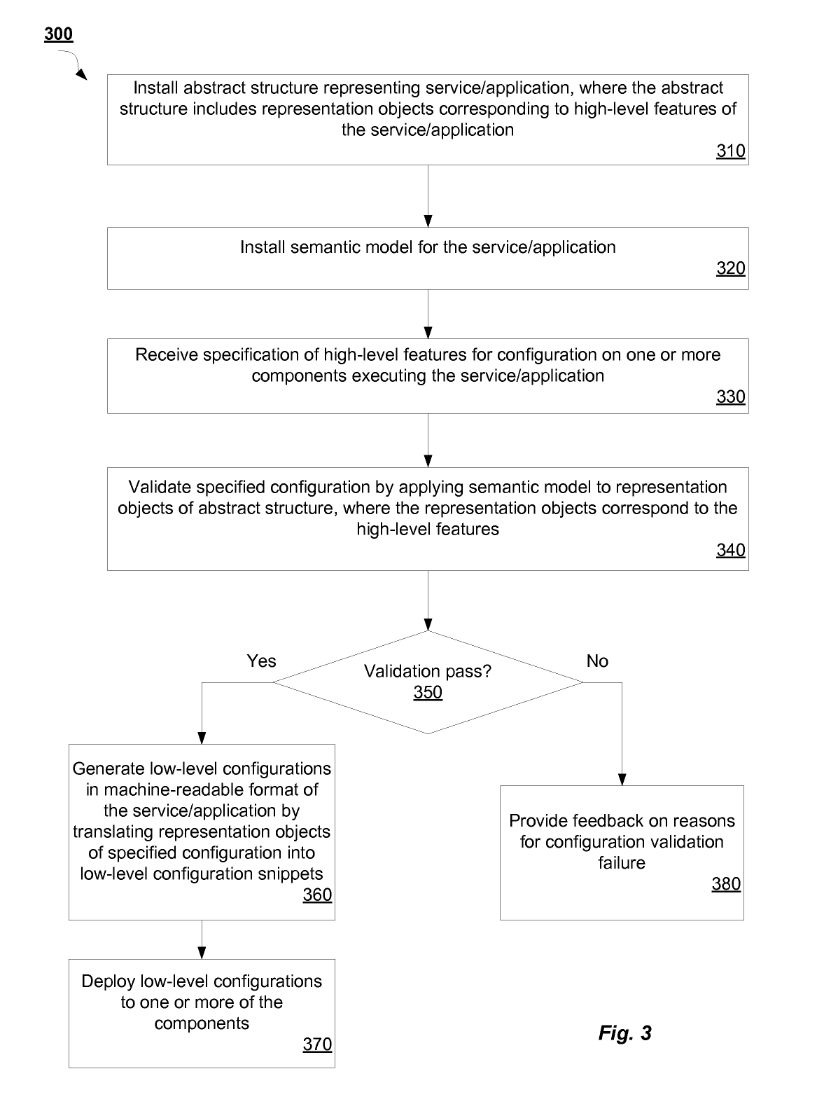

FIG. 3 is a flow diagram illustrating a method 300 for providing a generic semantic configuration service for computer systems according to an implementation of the disclosure. Method 300 may be performed by processing logic that may comprise hardware (e.g., circuitry, dedicated logic, programmable logic, microcode, etc.), software (such as instructions run on a processing device), firmware, or a combination thereof. In one implementation, method 300 is performed by generic configuration management component 115 of FIGS. 1 and 2.

Method 300 begins at block 310 where an abstract structure representing a service and/or application is installed as part of a generic configuration management component. In one implementation, the abstract structure is an arbitrary data representation (e.g., tree, graph, row-oriented database, logic database, map, set, any combination or composition of the above, etc.) including representation objects corresponding to high-level features of the service/application. At block 320, a semantic model for the service/application is installed. In one implementation, the semantic model specifies properties or rules that the generic configuration management component utilizes to automatically synthesize processes to solve constraints imposed upon the abstract structure.

At block 330, a specification of high-level features of the service/application is received for configuration on one or more components executing the service/application. In one implementation, an end user may indicate which high-level features to configure for the one or more components. Subsequently, at block 340, the specified configuration is validated by applying the semantic model to representation objects of the abstract structure that correspond to the specified high-level features.

Then, at decision block 350, it is determined whether the validation passed. If so, then, at block 360, low-level configurations are generated in a machine-readable format of the service/application. The low-level configurations may be generated by translating representation objects of the specified configuration into low-level configuration snippets of code. At block 370, the low-level configurations are deployed to the one or more components. Referred back to decision block 350, if the validation did not pass, the method 300 proceeds to block 380 where feedback is provided on the reasons for the configuration failure.

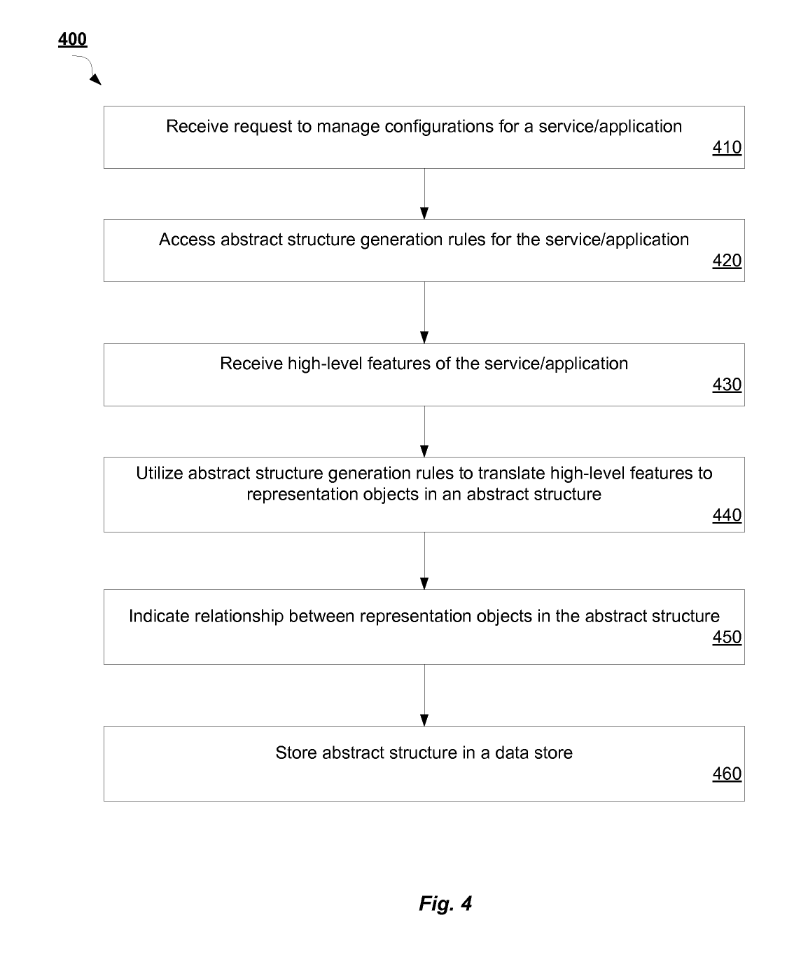

FIG. 4 is a flow diagram illustrating a method 400 for generating an abstract structure in a generic semantic configuration service for computer systems according to an implementation of the disclosure. Method 400 may be performed by processing logic that may comprise hardware (e.g., circuitry, dedicated logic, programmable logic, microcode, etc.), software (such as instructions run on a processing device), firmware, or a combination thereof. In one implementation, method 400 is performed by generic abstract structure declaration module 210 of FIG. 2.

Method 400 begins at block 410 where a request to management configurations for a service/application is received. Then, at block 420, abstract structure generation rules for the service/application are accessed. In one implementation, a domain expert for the service/application may have generated the abstract structure generation rules. At block 430, high-level features of the service/application are received. Then, at block 440, the abstract structure generation rules are used to translate the received high-level features into representation objects in an abstract structure. In one implementation, the abstract structure generation rules indicate how to format the information of the high-level features into the format of the representation object in the abstract structure and how to indicate relationships between the representation objects in the abstract structure.

Subsequently, at block 450, relationships between representation objects in the abstract structure are indicated. In one implementation, the abstract structure generation rules may specify how relationships in the abstract structure are indicate within an representation object. Lastly, at block 460, the abstract structure is stored in a data store for subsequent access and utilization.

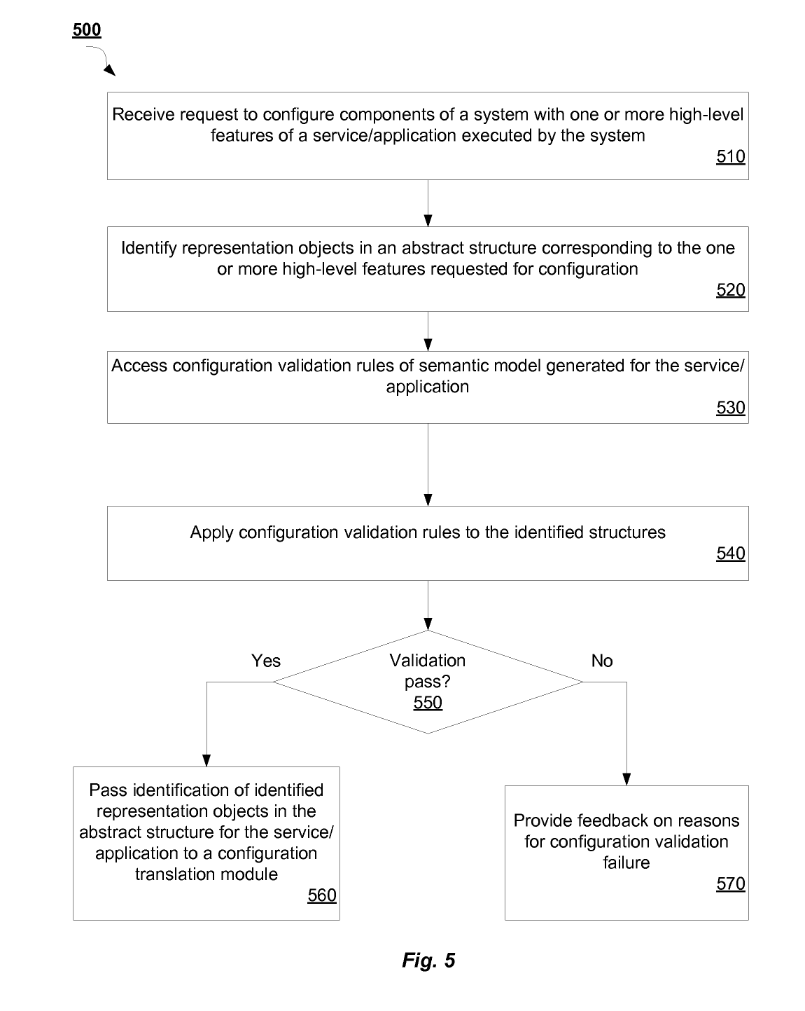

FIG. 5 is a flow diagram illustrating a method 500 for applying a semantic model for configuration validation in a generic semantic configuration service for computer systems according to an implementation of the disclosure. Method 500 may be performed by processing logic that may comprise hardware (e.g., circuitry, dedicated logic, programmable logic, microcode, etc.), software (such as instructions run on a processing device), firmware, or a combination thereof. In one implementation, method 500 is performed by semantic model validation module 220 of FIG. 2.

Method 500 begins at block 510 where a request to configuration components of a system is received. The request may specify one or more high-level features of the service/application for configuration. At block 520, representation objects in an abstract structure corresponding to the service/application are identified. The representation object identified are those that correspond to the specified one or more high-level features for configuration. At block 530, configuration validation rules of a semantic model are accessed. The configuration validation rules are specifically generated for the service/application. In one implementation, a domain expert familiar with the service/application may generate and store the configuration validation rules for the service/application.

Subsequently, at block 540, the configuration validation rules are applied to the identified representation objects. In one implementation, applying the configuration validation rules may include determining whether conflicts exist between high-level features, whether there is a dependency between high-level features, priority between high-level features, and so on. At decision block 550, it is determined whether the validation passes. If so, then at block 560 an identification of the identified representation objects in the abstract structure is passed to a configuration translation module for generation of low-level configuration code. If the validation did not pass at decision block 550, the method 500 proceeds to block 570 where feedback is provided on the reasons for the configuration validation failure.

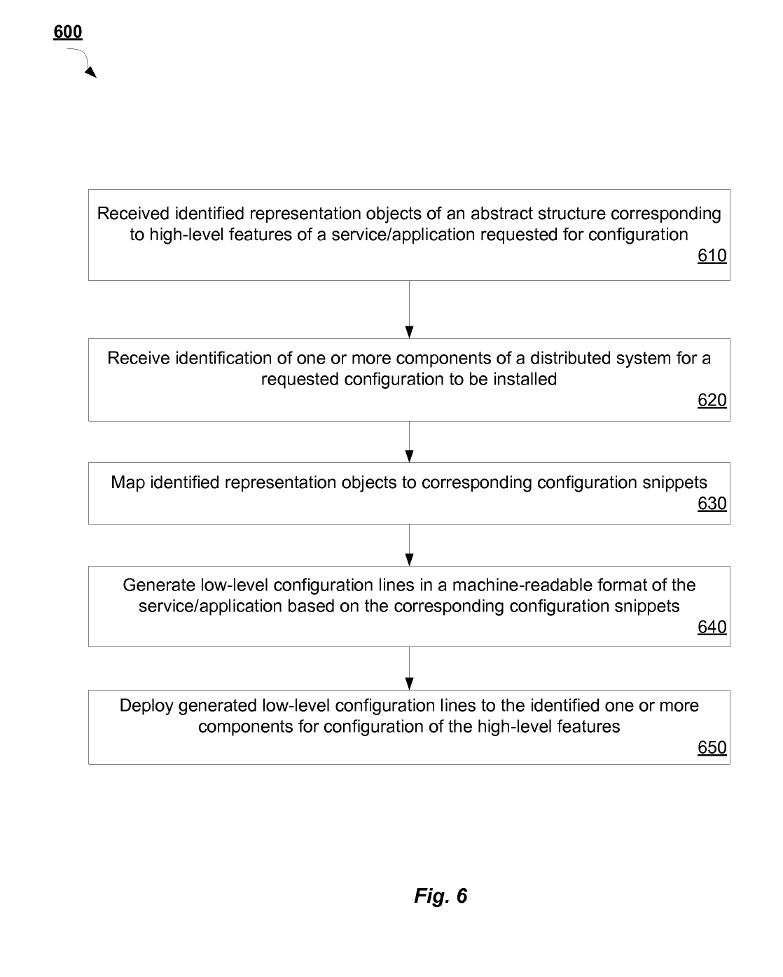

FIG. 6 is a flow diagram illustrating a method 600 for translating representation objects of an abstract structure into low-level configuration code in a generic semantic configuration service for computer systems according to an implementation of the disclosure. Method 600 may be performed by processing logic that may comprise hardware (e.g., circuitry, dedicated logic, programmable logic, microcode, etc.), software (such as instructions run on a processing device), firmware, or a combination thereof. In one implementation, method 600 is performed by configuration translation module 230 and configuration deployment module 240 of FIG. 2.

Method 600 begins at block 610 where identified representation objects of an abstract structure are received. In one implementation, the identified representation objects each correspond to high-level features of a service/application requested for configuration. At block 620, identification is received of one or more components of a distributed system in which to install the requested configuration. Then, at block 630, the identified representation objects are mapped to corresponding low-level configuration code snippets.

At block 640, low-level configuration codes lines are generated in a machine-readable format of the service/application based on the corresponding configuration code snippets. Lastly, at block 650, the generated low-level configuration code lines are deployed to the identified one or more components of the system. The deployment causes the one or more components to be configured with the high-level features.

FIG. 7 illustrates a diagrammatic representation of a machine in the example form of a computer system 700 within which a set of instructions, for causing the machine to perform any one or more of the methodologies discussed herein, may be executed. In alternative implementations, the machine may be connected (e.g., networked) to other machines in a LAN, an intranet, an extranet, or the Internet. The machine may operate in the capacity of a server or a client device in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 700 includes a processing device 702, a main memory 704 (e.g., read-only memory (ROM), flash memory, dynamic random access memory (DRAM) (such as synchronous DRAM (SDRAM) or DRAM (RDRAM), etc.), a static memory 706 (e.g., flash memory, static random access memory (SRAM), etc.), and a data storage device 718, which communicate with each other via a bus 730.

Processing device 702 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 is configured to execute the processing logic 726 for performing the operations and steps discussed herein.

The computer system 700 may further include a network interface device 708 communicably coupled to a network 720. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 716 (e.g., a speaker).

The data storage device 718 may include a machine-accessible storage medium 724 on which is stored software 726 embodying any one or more of the methodologies of functions described herein. The software 726 may also reside, completely or at least partially, within the main memory 704 as instructions 726 and/or within the processing device 702 as processing logic 726 during execution thereof by the computer system 700; the main memory 704 and the processing device 702 also constituting machine-accessible storage media.

The machine-readable storage medium 724 may also be used to store instructions 726 to implement a generic configuration management component 115 to provide a generic semantic configuration service in a computer system, such as the computer system described with respect to FIG. 1, and/or a software library containing methods that call the above applications. While the machine-accessible storage medium 728 is shown in an example implementation to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instruction for execution by the machine and that cause the machine to perform any one or more of the methodologies of the disclosure. The term “machine-accessible storage medium” shall accordingly be taken to include, but not be limited to, solid-state memories, and optical and magnetic media.

In the foregoing description, numerous details are set forth. It will be apparent, however, that the disclosure may be practiced without these specific details. In some instances, well-known structures and devices are shown in block diagram form, rather than in detail, in order to avoid obscuring the disclosure.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “sending”, “receiving”, “attaching”, “forwarding”, “caching”, “referencing”, “determining”, “installing”, “validating”, “generating”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosure also relates to an apparatus for performing the operations herein. This apparatus may be specially constructed for the required purposes, or it may comprise a general purpose computer selectively activated or reconfigured by a computer program stored in the computer. Such a computer program may be stored in a machine readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, the disclosure is not described with reference to any particular programming language. It will be appreciated that a variety of programming languages may be used to implement the teachings of the disclosure as described herein.

The disclosure may be provided as a computer program product, or software, that may include a machine-readable medium having stored thereon instructions, which may be used to program a computer system (or other electronic devices) to perform a process according to the disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), etc.

The terms “first”, “second”, “third”, “fourth”, etc. as used herein are meant as labels to distinguish among different elements and may not necessarily have an ordinal meaning according to their numerical designation.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

1. A method, comprising:
installing, by a processing device, an abstract data structure representing an application, the abstract data structure comprising representation objects corresponding to high-level features of the application;
installing a semantic model for the application;
receiving an identification of at least one of the high-level features to be configured on at least one component executing the application, the at least one component part of a distributed system providing the application;
validating, using the semantic model, a configuration of the representation objects of the abstract data structure corresponding to the at least one of the high-level features;
responsive to successfully validating the configuration, generating, by the processing device, low-level configuration code in a machine-readable format of the application from the representation objects corresponding to the at least one of the high-level features; and
deploying the generated low-level configuration code to the at least one component.

2. The method of claim 1, wherein other abstract data structures are installed for configurations of other applications.

3. The method of claim 1, wherein the abstract data structure comprises at least one of a tree data structure, a graph data structure, a row-oriented database, a logic database, a map, or a set.

4. The method of claim 1, wherein the high-level features each comprise a description of a user-visible unit of functionality of the application.

5. The method of claim 1, wherein the representation objects in the abstract data structure comprise information indicating relationships with other representation objects in the abstract data structure.

6. The method of claim 6, wherein the semantic model comprises configuration validation rules specifying acceptable interactions between the representation objects in the abstract data structure.

7. The method of claim 1, wherein the at least one component comprises one or more components affected by a configuration change to the application.

8. The method of claim 1, wherein when the configuration of the representation objects does not pass the validating, providing feedback on reasons for failure of the validating.

9. A system, comprising:
a memory to store an abstract data structure for an application; and
a processing device communicably coupled to the memory, wherein the processing device is to:
install the abstract data structure representing the application, the abstract data structure comprising representation objects corresponding to high-level features of the application;
install a semantic model for the application;
receive an identification of at least one of the high-level features to be configured on at least one component executing the application;
validate, using the semantic model, a configuration of the representation objects of the abstract data structure corresponding to the at least one of the high-level features; and
responsive to successfully validating the configuration, generate low-level configuration code in a machine-readable format of the application from the representation objects corresponding to the at least one of the high-level features

10. The system of claim 9, wherein the at least one component is part of a distributed system providing the application.

11. The system of claim 9, wherein other abstract data structures are installed for configurations of other applications.

12. The system of claim 9, wherein the abstract data structure comprises at least one of a tree data structure, a graph data structure, a row-oriented database, a logic database, a map, or a set.

13. The system of claim 9, wherein the high-level features each comprise a description of a user-visible unit of functionality of the application.

14. The system of claim 9, wherein the representation objects in the abstract data structure comprise information indicating relationships with other representation objects in the abstract data structure, and wherein the semantic model comprises configuration validation rules specifying acceptable interactions between the representation objects in the abstract data structure.

15. The system of claim 9, wherein the processing device is further to deploy the generated low-level configuration code to the at least one component.

16. A non-transitory machine-readable storage medium including instructions that, when accessed by a processing device, cause the processing device to:
install, by the processing device, an abstract data structure representing an application, the abstract data structure comprising representation objects corresponding to high-level features of the application;
install a semantic model for the application;
receive an identification of at least one of the high-level features to be configured on at least one component executing the application;
validate, using the semantic model, a configuration of the representation objects of the abstract data structure corresponding to the at least one of the high-level features; and
responsive to successfully validating the configuration, generate, by the processing device, low-level configuration code in a machine-readable format of the application from the representation objects corresponding to the at least one of the high-level features.

17. The non-transitory machine-readable storage medium of claim 16, wherein the at least one component is part of a distributed system providing the application.

18. The non-transitory machine-readable storage medium of claim 16, wherein the abstract data structure comprises at least one of a tree data structure, a graph data structure, a row-oriented database, a logic database, a map, or a set.

19. The non-transitory machine-readable storage medium of claim 16, wherein the high-level features each comprise a description of a user-visible unit of functionality of the application.

20. The non-transitory machine-readable storage medium of claim 16, wherein the representation objects in the abstract data structure comprise information indicating relationships with other representation objects in the abstract data structure, and wherein the semantic model comprises configuration validation rules specifying acceptable interactions between the representation objects in the abstract data structure.
